(19) United States
(12) Patent Application Publication
(10) Pub. No.: US 2023/0386326 A1
(43) Pub. Date: Nov. 30, 2023

(54) SYSTEMS AND METHODS FOR DETECTING PEDESTRIANS WITH CROSSWALKING OR JAYWALKING INTENT

(71) Applicant: Ford Global Technologies, LLC, Dearborn, MI (US)

(72) Inventors: Friederike Schneemann, München (DE); Alexander Metz, Munich (DE); Lorenzo Nardi, Munich (DE)

(21) Appl. No.: 18/321,120

(22) Filed: May 22, 2023

Related U.S. Application Data
(60) Provisional application No. 63/365,345, filed on May 26, 2022.

(51) Int. Cl. G08G 1/01; G06V 20/58; G06V 40/20; G06V 20/56

(52) U.S. Cl. CPC G08G 1/0133; G06V 20/58; G06V 40/20; G06V 20/588; G06V 2201/08

(57) ABSTRACT

Disclosed herein are systems, methods, and computer program products for detecting and using intentions of living actors in an environment. The methods comprise: obtaining, by a computing device, perception data associated with the environment; analyzing, by the computing device, the perception data to detect any crosswalks, mobile systems and living actors that are traveling on foot in the environment; and inferring, by the computing device, an existence of (a) a first living actor who likely has a crosswalking intent when one of the mobile systems is yielding at a respective crosswalk of the crosswalks proximate to the first living actor and/or (b) a second living actor who likely has a jaywalking intent based on movements of the second living actor in relation to a nearby one of the mobile systems that is parked.

### CROSS-REFERENCE TO RELATED APPLICATIONS

This application claims the benefit of U.S. provisional application Ser. No. 63/365,345 filed May 26, 2022, the disclosure of which is hereby incorporated in its entirety by reference herein.

### BACKGROUND

Modern day vehicles have at least one on-board computer and have internet/satellite connectivity. The software running on these on-board computers monitor and/or control operations of the vehicles. The vehicle also comprises monocular or stereo cameras and/or lidar detectors for detecting objects in proximity thereto. The cameras capture images of a scene. The lidar detectors generate lidar datasets that measure the distance from the vehicle to an object at a plurality of different times. These images and distance measurements can be used for detecting and tracking movements of the object, making predictions as to the object's trajectory, and planning paths of travel for the vehicle based on the predicted objects trajectory. When traversing roads, the vehicle should yield to objects (for example, pedestrians and other animals) that intend to cross the same. Intentions of the detected objects are not known to vehicles.

### SUMMARY

A method for detecting and using intentions of living actors in an environment of a vehicle may include obtaining, by a computing device, perception data associated with the environment, analyzing, by the computing device, the perception data to detect crosswalks, other vehicles and living actors that are traveling on foot in the environment, and inferring, by the computing device, an existence of at least one of (a) a first living actor having a crosswalking intent in response to one of the vehicles indicating yielding at a respective crosswalk of the crosswalks proximate to the first living actor and (b) a second living actor having a jaywalking intent based on movements of the second living actor within a predefined distance of one of the vehicles that is parked.

A system may include a processor, a non-transitory computer-readable storage medium comprising programming instructions that are configured to cause the processor to implement a method for detecting and using intentions of living actors in an environment, wherein the programming instructions comprise instructions to: obtain perception data associated with the environment, analyze the perception data to detect any crosswalks, vehicles and living actors that are traveling on foot in the environment; and infer an existence of at least one of (a) a first living actor having a crosswalking intent in response to one of the vehicles indicating yielding at a respective crosswalk of the crosswalks proximate to the first living actor and (b) a second living actor having a jaywalking intent based on movements of the second living actor within a predefined distance of one of the vehicles that is parked.

A non-transitory computer-readable medium that stores instructions that is configured to, when executed by at least one computing device, cause the at least one computing device to perform operations comprising: obtaining perception data associated with the environment, analyzing the perception data to detect any crosswalks, mobile systems and living actors that are traveling on foot in the environment and inferring an existence of at least one of (a) a first living actor who likely has a crosswalking intent when one of the mobile systems is yielding at a respective crosswalk of the crosswalks proximate to the first living actor and (b) a second living actor who likely has a jaywalking intent based on movements of the second living actor in relation to a nearby one of the mobile systems that is parked.

### BRIEF DESCRIPTION OF THE DRAWINGS

The accompanying drawings are incorporated herein and form a part of the specification.

FIG. 1 is an illustration of an illustrative system.

FIG. 2 is an illustration of an illustrative architecture for a vehicle.

FIG. 3 is an illustration of an illustrative architecture for a light detection and ranging (lidar) system employed by the vehicle shown in FIG. 2.

FIG. 4 is an illustration of an illustrative computing device.

FIG. 5 provides a block diagram of an illustrative vehicle trajectory planning process.

FIG. 6 provides a flow diagram of an illustrative method for detecting pedestrians with crosswalking or jaywalking intent and/or using the same to operate vehicle(s) and/or other robotic device(s).

FIG. 7 provides a flow diagram of an illustrative method for identifying or predicting an existence of pedestrians with crosswalking intent.

FIG. 8 provides a flow diagram of an illustrative method for identifying pedestrians with jaywalking intent.

FIGS. 9-15 each provide an illustration that is useful for understanding how a social feature is extracted from data.

FIG. 16 provides a flow diagram of an illustrative method for detecting and using intensions of living actors in an environment.

In the drawings, like reference numbers generally indicate identical or similar elements. Additionally, generally, the leftmost digit(s) of a reference number identifies the drawing in which the reference number first appears.

### DETAILED DESCRIPTION

Modern day vehicles have at least one on-board computer and have internet/satellite connectivity. The software running on these on-board computers monitor and/or control operations of the vehicles. The vehicle also comprises monocular or stereo cameras and/or lidar detectors for detecting objects in proximity thereto. The cameras capture images of a scene. The lidar detectors generate lidar datasets that measure the distance from the vehicle to an object at a plurality of different times. These images and distance measurements can be used for detecting and tracking movements of the object, making predictions as to the object's trajectory, and planning paths of travel for the vehicle based on the predicted objects trajectory. When traversing roads, the vehicle should yield to objects (for example, pedestrians and other animals) that intend to cross the same. However, intentions of the detected objects are not known to vehicles. This document describes methods and systems that are directed to addressing this problem and/or other issues.

When an autonomous vehicle (AV) approaches a crosswalk, it should yield to any pedestrian who intends to cross the street at that crosswalk. Therefore, the AV should be aware of (a) the pedestrian's presence and (b) the pedestrian's crossing intent. With regard to information (a), existing technologies fall short, particularly in situations where parts of the crosswalk are occluded (for example, by parked cars or vegetation). Pedestrians in such areas are unable to be detected by the sensors of the AV. With regard to information (b), existing technologies fall short, as detecting the crossing intent of a pedestrian is a very complex problem, particularly with the limited information that today's systems are able to acquire using existing sensors and other hardware. Most of today's crosswalking intention detection systems use machine learning technologies, which are based on the detected position and velocity of the pedestrian. Human drivers use a much richer set of features (like the pedestrian's body posture, gestures, gaze, scene context, etc.) to determine the pedestrian's crossing intention, which naturally leads to a better performance.

The proposed solution targets both problems by inferring the existence of a pedestrian with crossing intention from the observation that other (human) drivers yield at the crosswalk. Examples of problematic situations which are targeted by the proposed solution include: (1) a situation in which the AV is not aware of the existence of a pedestrian who has not yet been detected; and (2) a situation in which the AV detects a crossing intention of a pedestrian at a multi-lane crosswalk too late for a suitable reaction by the AV. In both of these situations, the cue for the existence of a pedestrian with crossing intent may be given by traffic stopped in front of the crosswalk which is yielding to the pedestrian. The proposed solution utilizes this observation by proposing a technical system which increases the AV's awareness for potentially crossing pedestrians by detecting other vehicles yielding at a crosswalk.

In order to navigate safely in urban environments, the AV also needs to be able to determine if a nearby pedestrian intends to jaywalk in front of the AV. Existing technologies mostly use machine learning based classifiers for this purpose. The machine learning based classifiers determine the jaywalking intent of a pedestrian based on the movement of the pedestrian towards or along the roadway edge. Such machine learning based classifiers typically struggle with correctly classifying situations in which a pedestrian interacts (enters, exits, loads) with a parked vehicle, as without taking the presence of the parked vehicle into consideration, the sensed movement of the pedestrian can be very similar to the movement of a pedestrian with a jaywalking intent. Therefore, these situations often result in false positive jaywalking predictions which result in uncomfortable and unnecessary halts or jukes of the AV.

The proposed solution targets this problem by extending features used within jaywalking classifiers to include social features which describe movement of a pedestrian in relation to the position and orientation of parked vehicle(s). Examples of problematic situations which are targeted by the proposed solution include: (1) a situation in which a pedestrian is walking along a parked truck to enter the same, but is falsely classified as intending to jaywalk; and (2) a situation in which a pedestrian is facing the roadway and intents to load his(her) truck, but is falsely classified as intending to jaywalk. By extending the features used within jaywalking classifiers to include social features, the jaywalking classifier has a reduced number of false positive jaywalking classifications in such situations.

In view of the forgoing, the present solution generally concerns implementing systems and methods for detecting pedestrians with crosswalking or jaywalking intent. The methods may generally involve: obtaining perception data; and analyzing the perception data to make certain detections and/or identifications. For example, crosswalks (marked and/or unmarked), vehicles, and/or pedestrians are detected. Additionally or alternatively, the following identification(s) is(are) made: vehicle(s) that are located on or near crosswalk(s); pedestrian(s) on or near the crosswalk(s); and/or pedestrian(s) in proximity to road edge(s).

When one or more detected vehicles are located on or near crosswalk(s), a machine learning classifier is used to classify each detected vehicle as a parked vehicle, a waiting vehicle (for example, at red light), a yielding vehicle (for example, for another actor) or a traffic queued vehicle. In some scenarios, the machine learning classifier described in U.S. patent Ser. No. 17/179,503 (filed Feb. 19, 2021) can be used for this classification of detected vehicles. The entire contents of this application are incorporated herein by reference. Next, operations are performed to: identify vehicle(s) from the vehicle(s) classified as yielding vehicle(s) which are located in front of a detected crosswalk (within a given maximum distance); and re-classifying the identified vehicles as crosswalk yielding vehicles.

When a crosswalk yielding vehicle exists and no pedestrian has been detected, an assumption may be made by the system that a pedestrian does exist. The system then uses a machine learning classifier to obtain a likelihood value indicating how likely an intent of the pedestrian is to cross along the crosswalk. The likelihood value is increased for the pedestrian when the respective crosswalk is associated with the vehicle classified as the crosswalk yielding vehicle. The amount by which the likelihood value is increased is determined by an observation function. The observation function may consider (i) the presence of yielding vehicle(s) at the respective crosswalk, (ii) a number of yielding vehicles and/or queuing vehicles at the respective crosswalk, (iii) likelihood value(s) associated with yielding vehicle classification(s), (iv) geometric reasoning information related to the pedestrian and crosswalk, (v) and/or geometric reasoning information relating to the vehicle and crosswalk. The geometric reasoning information can include, but is not limited to, distance(s) (for example, Euclidean distance(s)), relative positions, object alignment(s), and/or heading alignment(s).

When detected pedestrian(s) is(are) located on or near a crosswalk, the system uses a machine learning classifier to obtain, for each pedestrian detected on or near a crosswalk, a likelihood value indicating how likely an intent of the pedestrian is to cross along the crosswalk. The likelihood value is increased for the pedestrian in a manner similar to or the same as that described above.

When detected pedestrian(s) is(are) in proximity to road edge(s), the system performs operations to identify a parked vehicle that is closest to each detected pedestrian. If a closest vehicle is identified, social features are extracted from the perception data which describe a behavior of the pedestrian in relation to the closest parked vehicle. The social features may include, but are not limited to, a probability of the vehicle being parked, a distance from the pedestrian to the bounding box for the vehicle, an x-coordinate value of the pedestrian in a vehicle frame, a y-coordinate value of the pedestrian in a vehicle frame, an angle of the pedestrian in the vehicle frame, a difference in a distance from the pedestrian to a boundary of a closest lane and a distance from the parked vehicle to the boundary of the closest lane, a distance along a course ray to a bounding box of the parked vehicle, and a distance between a course ray and the bousing box of the parked vehicle. In contrast, if a closest parked vehicle is not identified, a default value is assigned to one or more social features for the pedestrian. The social features are used as inputs to a machine learning model that is trained to generate a likelihood that the pedestrian has an intent to jaywalk. The machine learning model can include, but is not limited to, a machine learning model that is similar to that described in U.S. patent application Ser. No. 17/394,777 filed on Aug. 5, 2021. The entire contents of this application are incorporated herein by reference.

Upon completing one or more of the above sets of operations, a motion plan for the AV may be generated using information specifying the crosswalks associated with the crosswalk yielding vehicles, the crosswalking likelihood value(s) for the detected pedestrian(s) that is(are) located on or near a crosswalk, and/or the jaywalking likelihood values for detected pedestrian that is(are) in proximity to road edge(s). The AV may be caused to follow the motion plan such that it approaches the crosswalk(s) in a desired manner (for example, at a relatively slow speed and ready to brake) (even when pedestrian(s) have not been detected by the AV on or near the crosswalk(s)) and/or portions of a road over which a pedestrian may jaywalk).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, semi-autonomous vehicles, manually operated vehicles, teleoperated vehicles, watercraft, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

Notably, the present solution is being described herein in the context of autonomous vehicles. However, the present solution is not limited to autonomous vehicle applications. The present solution can be used in other applications such as robotic application (for example to control movements of articulating arms) and/or system performance applications.

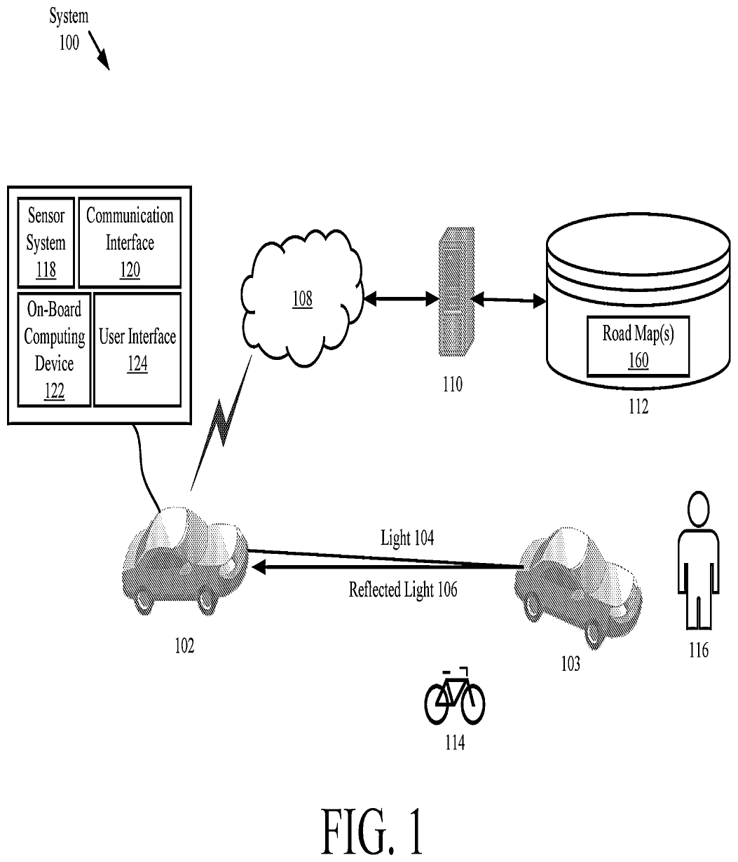

FIG. 1 illustrates an example system 100, in accordance with aspects of the disclosure. System 100 comprises a vehicle 102 which is caused to travel along a road in a semi-autonomous or autonomous manner. Vehicle 102 is also referred to herein as an AV 102. The AV 102 can include, but is not limited to, land vehicles (as shown in FIG. 1), aircraft, watercraft, subterrenes, spacecraft, drones and/or an articulating arm (for example, with a gripper at a free end). As noted above, except where specifically noted this disclosure is not necessarily limited to AV embodiments, and it may include non-autonomous vehicles in some embodiments.

AV 102 is generally configured to detect objects 103, 114, 116 in proximity thereto. The objects can include, but are not limited to, a vehicle 103, a cyclist 114 (such as a rider of a bicycle, electric scooter, motorcycle, or the like) and/or a pedestrian 116.

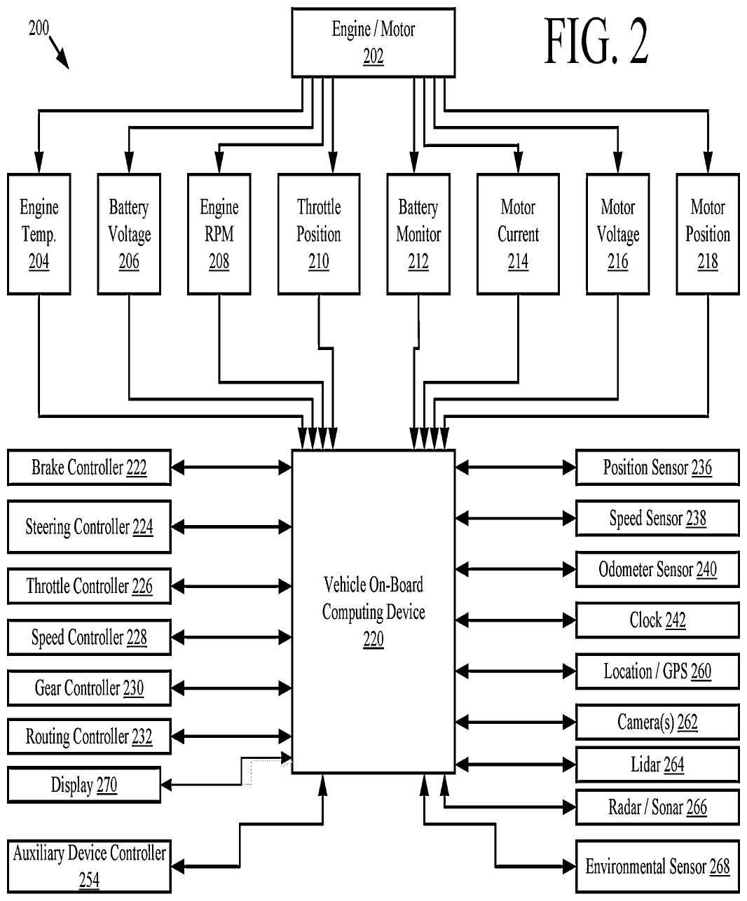

As illustrated in FIG. 1, the AV 102 may include a sensor system 118, an on-board computing device 122, a communications interface 120, and a user interface 124. AV 102 may further include certain components (as illustrated, for example, in FIG. 2) included in vehicles, which may be controlled by the on-board computing device 122 using a variety of communication signals and/or commands, such as, for example, acceleration signals or commands, deceleration signals or commands, steering signals or commands, braking signals or commands, etc.

The sensor system 118 may include one or more sensors that are coupled to and/or are included within the AV 102, as illustrated in FIG. 2. For example, such sensors may include, without limitation, a lidar system, a RADAR system, a laser detection and ranging (LADAR) system, a sound navigation and ranging (SONAR) system, camera(s) (for example, visible spectrum camera(s), infrared camera(s), etc.), temperature sensors, position sensors (for example, a global positioning system (GPS), etc.), location sensors, fuel sensors, motion sensors (for example, an inertial measurement unit (IMU), etc.), humidity sensors, occupancy sensors, and/or the like. The sensors are generally configured to generate sensor data. The sensor data may include information that describes the location of objects within the surrounding environment of the AV 102, information about the environment itself, information about the motion of the AV 102, information about a route of the vehicle, and/or the like. As AV 102 travels over a surface (for example, a road), at least some of the sensors may collect data pertaining to the surface.

As will be described in greater detail, AV 102 may be configured with a lidar system (for example, lidar system 264 of FIG. 2). The lidar system may be configured to transmit a light pulse 104 to detect objects located within a distance or range of distances of AV 102. Light pulse 104 may be incident on one or more objects (for example, AV 103) and be reflected back to the lidar system. Reflected light pulse 106 incident on the lidar system may be processed to determine a distance of that object to AV 102. The reflected light pulse 106 may be detected using, in some scenarios, a photodetector or array of photodetectors positioned and configured to receive the light reflected back into the lidar system. Lidar information, such as detected object data, is communicated from the lidar system to the on-board computing device 122. The AV 102 may also communicate lidar data to a remote computing device 110 (for example, a cloud processing system) over a network 108. Computing device 110 may be configured with one or more servers to process one or more processes of the technology described herein. Computing device 110 may also be configured to communicate data/instructions to/from AV 102 over network 108, to/from server(s) and/or database(s) 112.

It should be noted that the lidar systems for collecting data pertaining to the surface may be included in systems other than the AV 102 such as, without limitation, other vehicles (autonomous or driven), robots, satellites, etc.

Network 108 may include one or more wired or wireless networks. For example, the network 108 may include a cellular network (for example, a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

AV 102 may retrieve, receive, display, and edit information generated from a local application or delivered via network 108 from the database 112. Database 112 may be configured to store and supply raw data, indexed data, structured data, map data, program instructions or other configurations as is known.

The communications interface 120 may be configured to allow communication between AV 102 and external systems, such as, for example, external devices, sensors, other vehicles, servers, data stores, databases, etc. The communications interface 120 may utilize any now or hereafter known protocols, protection schemes, encodings, formats, packaging, etc. such as, without limitation, Wi-Fi, an infrared link, Bluetooth, etc. The user interface 124 may be part of peripheral devices implemented within the AV 102 including, for example, a keyboard, a touch screen display device, a microphone, and a speaker, etc. The vehicle also may receive state information, descriptive information or other information about devices or objects in its environment via the communication interface 120 over communication links such as those known as vehicle-to-vehicle, vehicle-to-object or other V2X communication links. The term “V2X” refers to a communication between a vehicle and any object that the vehicle may encounter or affect in its environment.

As noted above, the AV 102 may detect objects 103, 114, 116 in proximity thereto. Such object detections are facilitated using the sensor data generated by the sensor system 118 (for example, lidar datasets generated by an onboard lidar detector). The sensor data is processed by the onboard computing device 122 of the AV 102 and/or by the remote computing device 110 to obtain one or more predicted trajectories for the object given the sensor data. The predicted trajectories for the object may then be used to generate a trajectory for the AV 102. The AV 103 may then be caused by the on-board computing device to follow the trajectory.

FIG. 2 illustrates a system architecture 200 for a vehicle, in accordance with aspects of the disclosure. Vehicles 102 and/or 103 of FIG. 1 can have the same or similar system architecture as that shown in FIG. 2. Thus, the following discussion of system architecture 200 is sufficient for understanding vehicle(s) 102, 103 of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, the system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Revolutions Per Minute (RPM) sensor 208, and a throttle position sensor 210. If the vehicle is an electric or hybrid vehicle, then the vehicle may have an electric motor, and accordingly will have sensors such as a battery monitoring system 212 (to measure current, voltage and/or temperature of the battery), motor current 214 and voltage 216 sensors, and motor position sensors 218 such as resolvers and encoders 218.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device 220, it may be a separate device, or multiple clocks may be available.

The vehicle also will include various sensors that operate to gather information about the environment in which the vehicle is traveling. These sensors may include, for example: a location sensor 260 (for example, a GPS device); object detection sensors such as one or more cameras 262; a lidar sensor system 264; and/or a RADAR and/or SONAR system 266. The sensors also may include environmental sensors 268 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel.

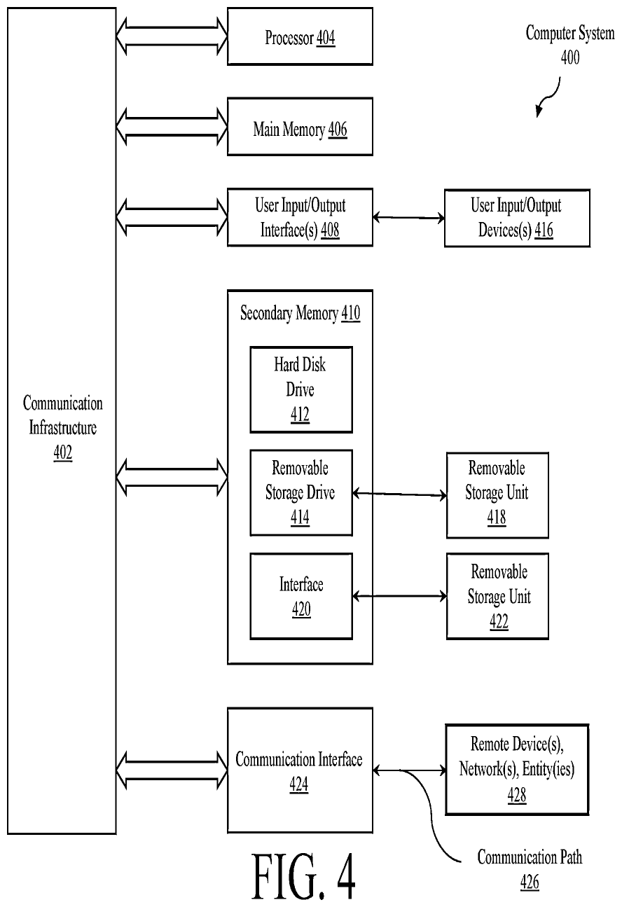

During operations, information is communicated from the sensors to a vehicle on-board computing device 220. The vehicle on-board computing device 220 may be implemented using the computer system of FIG. 4. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the vehicle on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors to the vehicle on-board computing device 220. The object detection information and/or captured images are processed by the vehicle on-board computing device 220 to detect objects in proximity to the vehicle. Any known or to be known technique for making an object detection based on sensor data and/or captured images can be used in the embodiments disclosed in this document.

Lidar information is communicated from lidar system 264 to the vehicle on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle. The manner in which the object detections are made by the vehicle on-board computing device 220 includes such capabilities detailed in this disclosure.

In addition, the system architecture 200 may include an onboard display device 270 that may generate and output an interface on which sensor data, vehicle status information, or outputs generated by the processes described in this document are displayed to an occupant of the vehicle. The display device may include, or a separate device may be, an audio speaker that presents such information in audio format.

The vehicle on-board computing device 220 may include and/or may be in communication with a routing controller 232 that generates a navigation route from a start position to a destination position for an autonomous vehicle. The routing controller 232 may access a map data store to identify possible routes and road segments that a vehicle can travel on to get from the start position to the destination position. The routing controller 232 may score the possible routes and identify a preferred route to reach the destination. For example, the routing controller 232 may generate a navigation route that minimizes Euclidean distance traveled or other cost function during the route, and may further access the traffic information and/or estimates that can affect an amount of time it will take to travel on a particular route. Depending on implementation, the routing controller 232 may generate one or more routes using various routing methods, such as Dijkstra's algorithm, Bellman-Ford algorithm, or other algorithms. The routing controller 232 may also use the traffic information to generate a navigation route that reflects expected conditions of the route (for example, current day of the week or current time of day, etc.), such that a route generated for travel during rush-hour may differ from a route generated for travel late at night. The routing controller 232 may also generate more than one navigation route to a destination and send more than one of these navigation routes to a user for selection by the user from among various possible routes.

In some scenarios, the vehicle on-board computing device 220 may determine perception information of the surrounding environment of the vehicle. Based on the sensor data provided by one or more sensors and location information that is obtained, the vehicle on-board computing device 220 may determine perception information of the surrounding environment of the vehicle. The perception information may represent what an ordinary driver would perceive in the surrounding environment of a vehicle. The perception data may include information relating to one or more objects in the environment of the vehicle. For example, the vehicle on-board computing device 220 may process sensor data (for example, lidar data, RADAR data, camera images, etc.) in order to identify objects and/or features in the environment of vehicle. The objects may include, but is not limited to, traffic signals, roadway boundaries, other vehicles, pedestrians, and/or obstacles. The vehicle on-board computing device 220 may use any now or hereafter known object recognition algorithms, video tracking algorithms, and computer vision algorithms (for example, track objects frame-to-frame iteratively over a number of time periods) to determine the perception.

In those or other scenarios, the vehicle on-board computing device 220 may also determine, for one or more identified objects in the environment, the current state of the object. The state information may include, without limitation, for each object: a current location; a current speed; an acceleration; a current heading; a current pose; a current shape, size and/or footprint; an object type or classification (for example, vehicle. pedestrian, bicycle, static object, or obstacle); and/or other state information.

The vehicle on-board computing device 220 may perform one or more prediction and/or forecasting operations. For example, the vehicle on-board computing device 220 may predict future locations, trajectories, and/or actions of one or more objects. For example, the vehicle on-board computing device 220 may predict the future locations, trajectories, and/or actions of the objects based at least in part on perception information (for example, the state data for each object comprising an estimated shape and pose determined as discussed below), location information, sensor data, and/or any other data that describes the past and/or current state of the objects, the vehicle, the surrounding environment, and/or their relationship(s). For example, if an object is a vehicle and the current driving environment includes an intersection, the vehicle on-board computing device 220 may predict whether the object will likely move straight forward or make a turn. If the perception data indicates that the intersection has no traffic light, the vehicle on-board computing device 220 may also predict whether the vehicle may have to fully stop prior to entering the intersection.

In those or other scenarios, the vehicle on-board computing device 220 may determine a motion plan for the vehicle. For example, the vehicle on-board computing device 220 may determine a motion plan for the vehicle based on the perception data and/or the prediction data. Specifically, given predictions about the future locations of proximate objects and other perception data, the vehicle on-board computing device 220 can determine a motion plan for the vehicle that best navigates the vehicle relative to the objects at their future locations.

In those or other scenarios, the vehicle on-board computing device 220 may receive predictions and make a decision regarding how to handle objects and/or actors in the environment of the vehicle. For example, for a particular actor (for example, a vehicle with a given speed, direction, turning angle, etc.), the vehicle on-board computing device 220 decides whether to overtake, yield, stop, and/or pass based on, for example, traffic conditions, map data, state of the autonomous vehicle, etc. Furthermore, the vehicle on-board computing device 220 also plans a path for the vehicle to travel on a given route, as well as driving parameters (for example, distance, speed, and/or turning angle). That is, for a given object, the vehicle on-board computing device 220 decides what to do with the object and determines how to do it. For example, for a given object, the vehicle on-board computing device 220 may decide to pass the object and may determine whether to pass on the left side or right side of the object (including motion parameters such as speed). The vehicle on-board computing device 220 may also assess the risk of a collision between a detected object and the vehicle. If the risk exceeds an acceptable threshold, it may determine whether the collision can be avoided if the vehicle follows a defined vehicle trajectory and/or implements one or more dynamically generated emergency maneuvers in a time period (for example, N milliseconds). If the collision can be avoided, then the vehicle on-board computing device 220 may execute one or more control instructions to perform a cautious maneuver (for example, mildly slow down, accelerate, change lane, or swerve). In contrast, if the collision cannot be avoided, then the vehicle on-board computing device 220 may execute one or more control instructions for execution of an emergency maneuver (for example, brake and/or change direction of travel).

As discussed above, planning and control data regarding the movement of the vehicle is generated for execution. The vehicle on-board computing device 220 may, for example: control braking via a brake controller; direction via a steering controller; speed and acceleration via a throttle controller (in a gas-powered vehicle) or a motor speed controller (such as a current level controller in an electric vehicle); change gears via a differential gear controller (in vehicles with transmissions); and/or control other operations via other controllers.

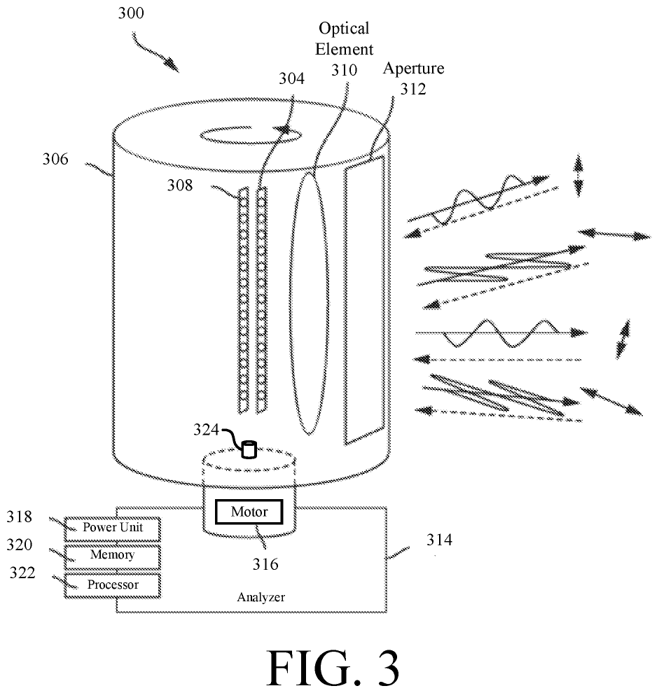

FIG. 3 illustrates an architecture for a lidar system 300, in accordance with aspects of the disclosure. Lidar system 264 of FIG. 2 may be the same as or substantially similar to the lidar system 300. As such, the discussion of lidar system 300 is sufficient for understanding lidar system 264 of FIG. 2. It should be noted that the lidar system 300 of FIG. 3 is merely an example lidar system and that other lidar systems are further completed in accordance with aspects of the present disclosure, as should be understood by those of ordinary skill in the art.

As shown in FIG. 3, the lidar system 300 includes a housing 306 which may be rotatable 360° about a central axis such as hub or axle 324 of a motor 316. The housing may include an emitter/receiver aperture 312 made of a material transparent to light. Although a single aperture is shown in FIG. 3, the present solution is not limited in this regard. In other scenarios, multiple apertures for emitting and/or receiving light may be provided. Either way, the lidar system 300 can emit light through one or more of the aperture(s) 312 and receive reflected light back toward one or more of the aperture(s) 312 as the housing 306 rotates around the internal components. In alternative scenarios, the outer shell of housing 306 may be a stationary dome, at least partially made of a material that is transparent to light, with rotatable components inside of the housing 306.

Inside the rotating shell or stationary dome is a light emitter system 304 that is configured and positioned to generate and emit pulses of light through the aperture 312 or through the transparent dome of the housing 306 via one or more laser emitter chips or other light emitting devices. The light emitter system 304 may include any number of individual emitters (for example, 8 emitters, 64 emitters, or 128 emitters). The emitters may emit light of substantially the same intensity or of varying intensities. The lidar system will also include a light detector 308 containing a photodetector or array of photodetectors positioned and configured to receive light reflected back into the system. The light emitter system 304 and light detector 308 would rotate with the rotating shell, or they would rotate inside the stationary dome of the housing 306. One or more optical element structures 310 may be positioned in front of the light emitter system 304 and/or the light detector 308 to serve as one or more lenses or wave plates that focus and direct light that is passed through the optical element structure 310.

One or more optical element structures 310 may be positioned in front of a mirror (not shown) to focus and direct light that is passed through the optical element structure 310. As shown below, the system includes an optical element structure 310 positioned in front of the mirror and connected to the rotating elements of the system so that the optical element structure 310 rotates with the mirror. Alternatively or in addition, the optical element structure 310 may include multiple such structures (for example lenses and/or waveplates). Optionally, multiple optical element structures 310 may be arranged in an array on or integral with the shell portion of the housing 306.

The lidar system 300 will include a power unit 318 to power the light emitter system 304, motor 316, and electronic components. The lidar system 300 also includes an analyzer 314 with elements such as a processor 322 and non-transitory computer-readable memory 320 containing programming instructions that are configured to enable the system to receive data collected by the light detector unit, analyze it to measure characteristics of the light received, and generate information that a connected system can use to make decisions about operating in an environment from which the data was collected. Optionally, the analyzer 314 may be integral with the lidar system 300 as shown, or some or all of it may be external to the lidar system and communicatively connected to the lidar system via a wired or wireless communication network or link.

The present solution can be implemented, for example, using one or more computer systems, such as computer system 400 shown in FIG. 4. Computer system 400 can be any computer capable of performing the functions described herein. The on-board computing device 122 of FIG. 1, computing device 110 of FIG. 1, robotic device(s) 152 of FIG. 1, mobile communication device(s) 156 of FIG. 1, and/or the vehicle on-board computing device 220 of FIG. 2 may be the same as or similar to computing system 400. As such, the discussion of computing system 400 is sufficient for understanding the devices 110, 122, 152, 156 and 220 of FIGS. 1-2.

Computing system 400 may include more or less components than those shown in FIG. 4. However, the components shown are sufficient to disclose an illustrative solution implementing the present solution. The hardware architecture of FIG. 4 represents one implementation of a representative computing system configured to operate a vehicle, as described herein. As such, the computing system 400 of FIG. 4 implements at least a portion of the method(s) described herein.

Some or all components of the computing system 400 can be implemented as hardware, software and/or a combination of hardware and software. The hardware includes, but is not limited to, one or more electronic circuits. The electronic circuits can include, but are not limited to, passive components (for example, resistors and capacitors) and/or active components (for example, amplifiers and/or microprocessors). The passive and/or active components can be adapted to, arranged to and/or programmed to perform one or more of the methodologies, procedures, or functions described herein.

Computer system 400 includes one or more processors (also called central processing units, or CPUs), such as a processor 404. Processor 404 is connected to a communication infrastructure or bus 402. One or more processors 404 may each be a graphics processing unit (GPU). In some scenarios, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 416, such as monitors, keyboards, pointing devices, etc., that communicate with communication infrastructure 402 through user input/output interface(s) 408. Computer system 400 further includes a main or primary memory 406, such as random access memory (RAM). Main memory 406 may include one or more levels of cache. Main memory 406 has stored therein control logic (i.e., computer software) and/or data.

One or more secondary storage devices or memories 410 may be provided with computer system 400. Secondary memory 410 may include, for example, a hard disk drive 412 and/or a removable storage device or drive 414. Removable storage drive 414 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be an external hard drive, a universal serial bus (USB) drive, a memory card such as a compact flash card or secure digital memory, a floppy disk, a magnetic tape, a compact disc, a DVD, an optical storage disk, and/or any other computer data storage device. Removable storage drive 414 reads from and/or writes to removable storage unit 414 in a well-known manner.

In some scenarios, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In some scenarios, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 400, main memory 406, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use the present solution using data processing devices, computer systems and/or computer architectures other than that shown in FIG. 4. In particular, the present solution can operate with software, hardware, and/or operating system implementations other than those described herein.

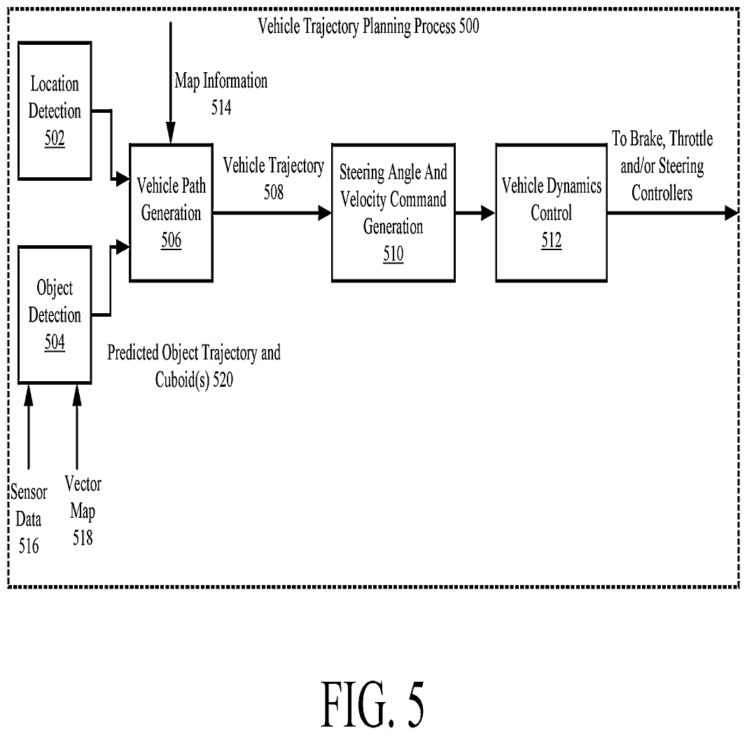

FIG. 5 provides a block diagram that is useful for understanding how motion or movement of an AV is achieved in accordance with the present solution. In one implementation, all of the operations performed in blocks 502-512 can be performed by the on-board computing device (for example, on-board computing device 122 of FIGS. 1 and/or 220 of FIG. 2) of a vehicle (for example, AV 102 of FIG. 1).

In block 502, a location of the AV (for example, AV 102 of FIG. 1) is detected. This detection can be made based on sensor data output from a location sensor (for example, location sensor 260 of FIG. 2) of the AV. This sensor data can include, but is not limited to, GPS data. The detected location of the AV is then passed to block 506.

In block 504, an object (for example, vehicle 103 of FIG. 1) is detected within proximity of the AV (for example, <100+meters). This detection is made based on sensor data output from a camera (for example, camera 262 of FIG. 2) of the AV and/or a lidar system (for example, lidar system 264 of FIG. 2) of the AV. For example, image processing is performed to detect an instance of an object of a certain class (for example, a vehicle, cyclist or pedestrian) in an image. The image processing/object detection can be achieved in accordance with any known or to be known image processing/object detection algorithm.

Additionally, a predicted trajectory is determined in block 504 for the object. The object's trajectory is predicted in block 504 based on the object's class, cuboid geometry(ies), cuboid heading(s) and/or contents of a map 518 (for example, sidewalk locations, lane locations, lane directions of travel, driving rules, etc.). The manner in which the cuboid geometry(ies) and heading(s) are determined will become evident as the discussion progresses. At this time, it should be noted that the cuboid geometry(ies) and/or heading(s) are determined using sensor data of various types (for example, 2D images, 3D lidar point clouds) and a vector map 518 (for example, lane geometries). Techniques for predicting object trajectories based on cuboid geometries and headings are well known in the art. One technique involves predicting that the object is moving on a linear path in the same direction as the heading direction of a cuboid. The predicted object trajectories can include, but are not limited to, the following trajectories: a trajectory defined by the object's actual speed (for example, 1 mile per hour) and actual direction of travel (for example, west); a trajectory defined by the object's actual speed (for example, 1 mile per hour) and another possible direction of travel (for example, south, south-west, or X (for example, 40°) degrees from the object's actual direction of travel in a direction towards the AV) for the object; a trajectory defined by another possible speed for the object (for example, 2-10 miles per hour) and the object's actual direction of travel (for example, west); and/or a trajectory defined by another possible speed for the object (for example, 2-10 miles per hour) and another possible direction of travel (for example, south, south-west, or X (for example, 40°) degrees from the object's actual direction of travel in a direction towards the AV) for the object. The possible speed(s) and/or possible direction(s) of travel may be pre-defined for objects in the same class and/or sub-class as the object. It should be noted once again that the cuboid defines a full extent of the object and a heading of the object. The heading defines a direction in which the object's front is pointed, and therefore provides an indication as to the actual and/or possible direction of travel for the object.

Information 520 specifying the object's predicted trajectory, the cuboid geometry(ies)/heading(s) is provided to block 506. In some scenarios, a classification of the object is also passed to block 506. In block 506, a vehicle trajectory is generated using the information from blocks 502 and 504. Techniques for determining a vehicle trajectory using cuboids are well known in the art. For example, in some scenarios, such a technique involves determining a trajectory for the AV that would pass the object when the object is in front of the AV, the cuboid has a heading direction that is aligned with the direction in which the AV is moving, and the cuboid has a length that is greater than a threshold value. The present solution is not limited to the particulars of this scenario. The vehicle trajectory 520 can be determined based on the location information from block 502, the object detection information from block 504, and/or map information 514 (which is pre-stored in a data store of the vehicle). The map information 514 may include, but is not limited to, all or a portion of road map(s) 160 of FIG. 1. The vehicle trajectory 520 may represent a smooth path that does not have abrupt changes that would otherwise provide passenger discomfort. For example, the vehicle trajectory is defined by a path of travel along a given lane of a road in which the object is not predicted to travel within a given amount of time. The vehicle trajectory 520 is then provided to block 508.

In block 508, a steering angle and velocity command is generated based on the vehicle trajectory 520. The steering angle and velocity command are provided to block 510 for vehicle dynamics control, i.e., the steering angle and velocity command causes the AV to follow the vehicle trajectory 508.

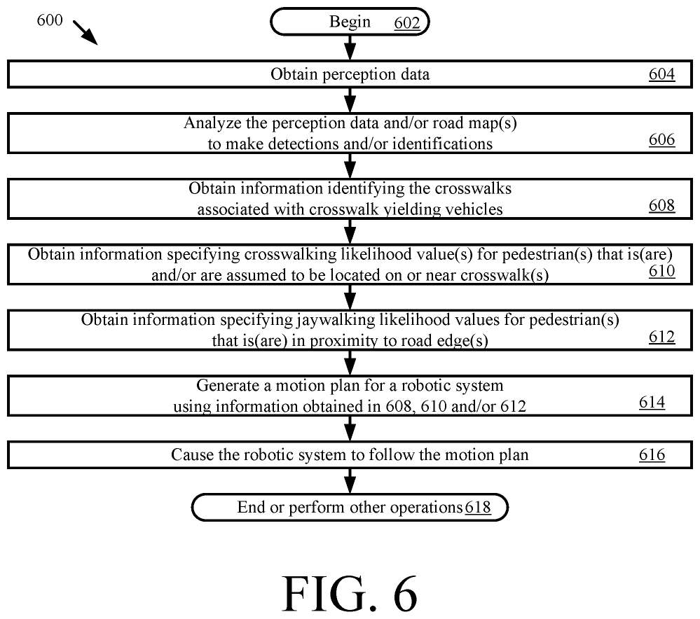

FIG. 6 provides a flow diagram of an illustrative method 600 for detecting pedestrians (for example, pedestrian 116 of FIG. 1) with crosswalking or jaywalking intent and/may using the same to operate robotic system(s) (for example, vehicle 102 of FIG. 1). Method 600 can be carried out by one or more computing devices. The computing devices include, but are not limited to, an on-board computing device (for example, vehicle on-board computing device 220 of FIG. 2) of the robotic system and/or by a remote computing device (for example, computing device 110 of FIG. 1).

Method 600 begins with block 602 and continues with block 604, where perception data is obtained by computing device(s). The perception data may include, but is not limited to, images, LiDAR data, radar data, sonar data, location data, environmental data and/or any other data generated by sensor(s) (for example, sensor(s) 236-240, 260-268 of FIG. 2) of the robotic system. The perception data is analyzed by the computing device(s) in 606 to make detection(s) and/or identification(s). For example, the computing device(s) analyze the perception data and/or road maps to: detect crosswalks (marked and/or unmarked), vehicles, and/or pedestrians; identify vehicle(s) that are located on or near crosswalk(s); identify pedestrian(s) on or near the crosswalk(s); and/or identify pedestrian(s) in proximity to road edge(s). The perception data analysis may involve image analysis and/or 3D point cloud analysis (data point clustering and labeling).

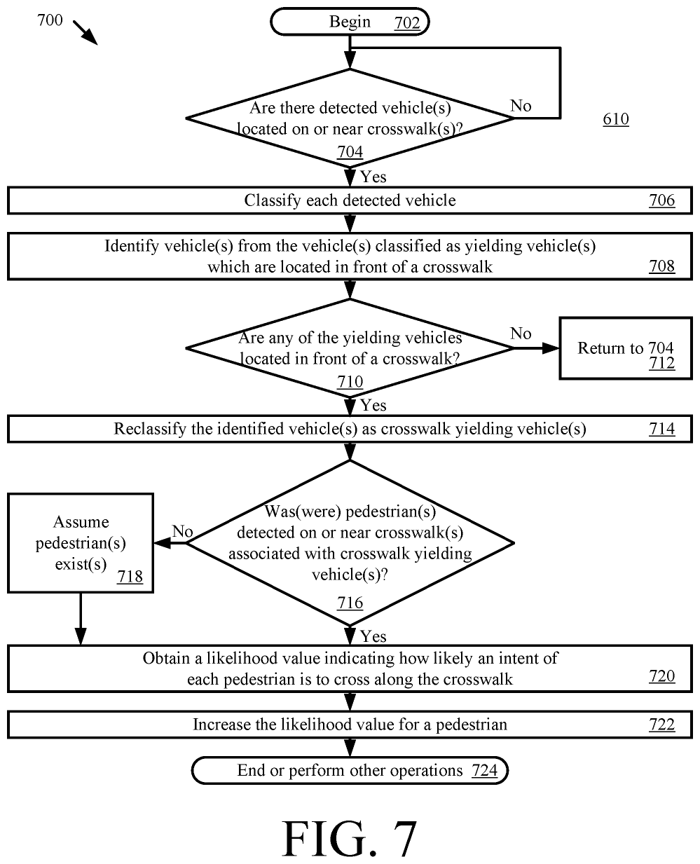

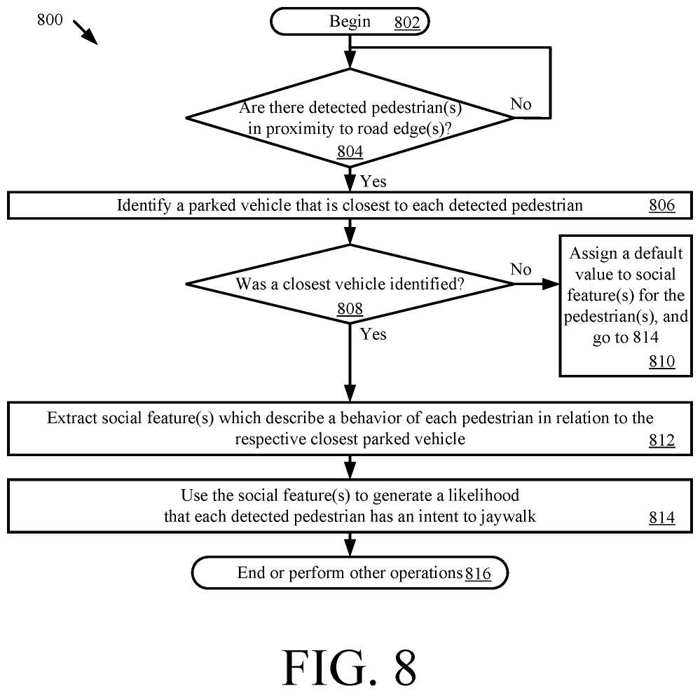

In block 608, the computing device(s) obtain(s) information that identifies crosswalks associated with crosswalk yielding vehicle. The computing device(s) may also obtain information specifying crosswalking likelihood value(s) for pedestrian(s) that is(are) and/or are assumed to be located on or near crosswalk(s), as shown by block 610. An illustrative way in which the information obtained in blocks 608 and 610 is generated will be described below in relation to FIG. 7. The computing device(s) further obtain information specifying jaywalking likelihood values for pedestrian(s) that is(are) in proximity to road edge(s). An illustrative way in which this information is generated will be described below in relation to FIG. 8.

The information obtained in blocks 608, 610 and/or 612 is used in 614 by the computing device(s) to generate a motion plan for the robotic system. The robotic system is then caused to follow the motion plan in block 616. For example, the robotic system comprises a vehicle which is caused to approach crosswalk(s) at a relatively slow speed and ready to brake (even when pedestrian(s) have not been detected by the computing device(s) on or near the crosswalk(s) and/or portions of a road over which a pedestrian may jaywalk). The manner in which the vehicle is caused to follow the motion plan is the same as or similar to that described above in relation to FIG. 5. The present solution is not limited to the particulars of this example.

FIG. 7 provides a flow diagram of an illustrative method 700 for identifying or predicting an existence of pedestrians with crosswalking intent. Method 700 may be carried out by one or more computing devices. The computing devices include, but are not limited to, an on-board computing device (for example, vehicle on-board computing device 220 of FIG. 2) of the robotic system and/or by a remote computing device (for example, computing device 110 of FIG. 1).

Method 700 generally contains operations to identify crosswalks for which vehicles are yielding and to increase likelihood values of crossing intentions for pedestrians near the identified crosswalks. Previous solutions for determining the intentions of pedestrians do not make use of information determined from the context of vehicle(s) yielding at crosswalk(s) to infer the existence of pedestrian(s) with crosswalking intention(s). Method 700 advantageously allows the robotic systems (for example, AVs) to approach such crosswalk(s) with more caution, which results in more comfortable and human like movement (for example, driving) behavior of the robotic system(s).

Method 700 begins with block 702 and continues with block 704 where a decision is made as to whether there are any detected vehicle(s) located on or near crosswalk(s). If not [704:NO], method 700 repeats this decision. In so [704:YES], each detected vehicle is classified. This classification can be achieved using a machine learning based classifier that is trained to classify each detected vehicle as a parked vehicle, a waiting vehicle (for example, at red light), a yielding vehicle (for example, for another actor) or a traffic queued vehicle. The machine learning based classifier can include, but is not limited to, a neuronal network-based classifier, a Random Forest (RF) based classifier, a Support Vector Machines (SVM) based classifier, and/or a classifier described in U.S. patent Ser. No. 17/179,503. The term “parked vehicle” may refer to a vehicle that has been brought to a halt and remains temporarily in the halted state. The term “waiting vehicle” may refer to a vehicle that cannot drive or otherwise act until a thing happens (for example, a light change from red to green, a passenger arrives the vehicles, another vehicle or other objecting is moved that is blocking the vehicle's ability to continue traversing a road, etc.). The term “yielding vehicle” may refer to vehicle that is letting other road users (for example, vehicle(s) 103 of FIG. 1, pedestrian(s) 116 of FIG. 1, cyclist(s) 114 of FIG. 1, animals, etc.) go first. The term “traffic queued vehicle” may refer to a vehicle queuing in traffic.

Next in block 708, the computing device(s) performs operations to identify vehicle(s), from the vehicle(s) classified as yielding vehicle(s), which are located in front of crosswalk(s) (for example, within a given minimum predefined distance). The road map, vehicle location information (for example, extracted from GPS data, images, and/or 3D point clouds) and/or geometric reasoning may be used to facilitate this identification. The road map includes crosswalk location information and lane information (for example, directions of vehicle travel). In some scenarios, the computing device makes such an identification by (i) determining the lane a vehicle is currently occupying (for example, using the position of the vehicle and given map data) and (ii) checking whether this lane or any of its successors is linked to a crosswalk within the given map data.

If one or more vehicles were not identified in block 708 [710:NO], then method 700 returns to block 704 as shown by block 712. In contrast, if vehicle(s) were identified in 708 [710:YES], then the computing device(s) perform operations in block 714 to reclassify the identified vehicle(s) as crosswalk yielding vehicle(s). A list of crosswalk yielding vehicles may be generated and maintained by the computing device(s), which can be directly used by a motion planning algorithm for determining a motion plan for a robotic system (for example, in block 614 of FIG. 6).

Next in block 716, the computing device determines whether there were any pedestrian(s) detected on or near crosswalk(s) associated with the crosswalk yielding vehicle(s). If not [716:NO], then an assumption is made the pedestrian(s) do(es) exit(s) on or near such crosswalk(s) and method 700 continues to block 720. In block 720, the computing device obtains a likelihood value indicating how likely an intent of each pedestrian is to cross along the crosswalk(s). The likelihood value can be generated using a crosswalking classifier or other machine learning algorithm that is trained to decide if observed behavior(s) of pedestrian(s) is(are) typical for pedestrian(s) who aim(s) to cross the street at a crosswalk. For example, the crosswalking classifier decides that there is a relatively high likelihood that a pedestrian will cross a street along a crosswalk when the observed behavior of the pedestrian includes (i) moving towards an intersection, (ii) pushing a button for the crosswalk, and (iii) waiting at a curb ramp. In contrast, the crosswalking classifier decodes that the is a relatively low likelihood that a pedestrian will cross a street along a crosswalk when the observed behavior of the pedestrian includes (i) moving towards an intersection and (ii) turning and/or moving away from a curb ramp. The present solution is not limited to the particulars of this example.

In block 722, each likelihood value is increased by an amount that is determined using an observation function. The observation function describes how much the likelihood of the crosswalking intent depends on certain factors. The factors can include, but are not limited to, (i) the presence of yielding vehicle(s) at the respective crosswalk, (ii) a number of yielding vehicles and/or queuing vehicles at the respective crosswalk, (iii) likelihood value(s) associated with yielding vehicle classification(s), (iv) geometric reasoning information associated with the pedestrian and crosswalk, and/or (v) geometric reasoning information associated with the vehicle and crosswalk. The geometric reasoning information can include, but is not limited to, distance(s) (for example, Euclidean distance(s)), relative positions, alignment, and/or heading alignment. Subsequently, block 724 is performed where method 700 ends or other operations are performed (for example, return to block 702).

FIG. 8 provides a flow diagram of an illustrative method 800 for identifying pedestrians with jaywalking intent. Method 800 can be performed by one or more computing devices. The computing devices include, but are not limited to, an on-board computing device (for example, vehicle on-board computing device 220 of FIG. 2) of the robotic system and/or by a remote computing device (for example, computing device 110 of FIG. 1).

Method 800 generally contains operations to identify pedestrian(s) that are in proximity to road edge(s), determine which parked vehicle(s) is(are) closest to the identified pedestrian(s), extract social feature(s) for the identified pedestrian(s), and determine likelihood(s) that the identified pedestrian(s) will jaywalk based on the social feature(s) and/or other information. The social features capture the movement(s) of the pedestrian(s) in relation to the position and orientation of nearby parked vehicle(s). By adding these social feature(s) as inputs to a jaywalking classifier, the jaywalking classifier can better identify pedestrians with an actual jaywalking intent from those which are close to the road edge but are interacting with a parked vehicle (and therefore do not have a jaywalking intent). This results in a reduction in false positive jaywalking classifications for pedestrians interacting with parked vehicles and therefore less unnecessary halts or jukes of robotic system(s).

Method 800 begins with block 802 and continues with block 804 where the computing device(s) determine(s) whether any detected pedestrians are located in proximity to road edge(s) (for example, within 0-5 feet, 0-4 feet, 0-3 feet, 0-2 feet, or 0-1 feet) and identify the same. This determination can be achieved using sensor data (for example, images and/or 3D point clouds), road map data and geometric reasoning.

Once these detected pedestrian(s) is(are) identified, the computing device(s) perform(s) operations in block 806 to identify a parked vehicle that is closest to the same. These operations can include, but are not limited to: identifying all vehicles which have center points within a maximum range (for example, 0-10 meters) of each pedestrian that is in proximity to the road edge(s); discarding ones of the identified vehicles which have parked likelihood values less than or equal to a threshold value (for example, <0.5); and selecting the vehicle from the remaining identified vehicles which is associated with an outer bounding box that is closest to the pedestrian.

If a closest parked vehicle is not identified for a pedestrian [808:NO], then a default value is assigned to social feature(s) associated with the pedestrian as shown by block 810. The method 800 then goes to block 814 which will be discussed below.

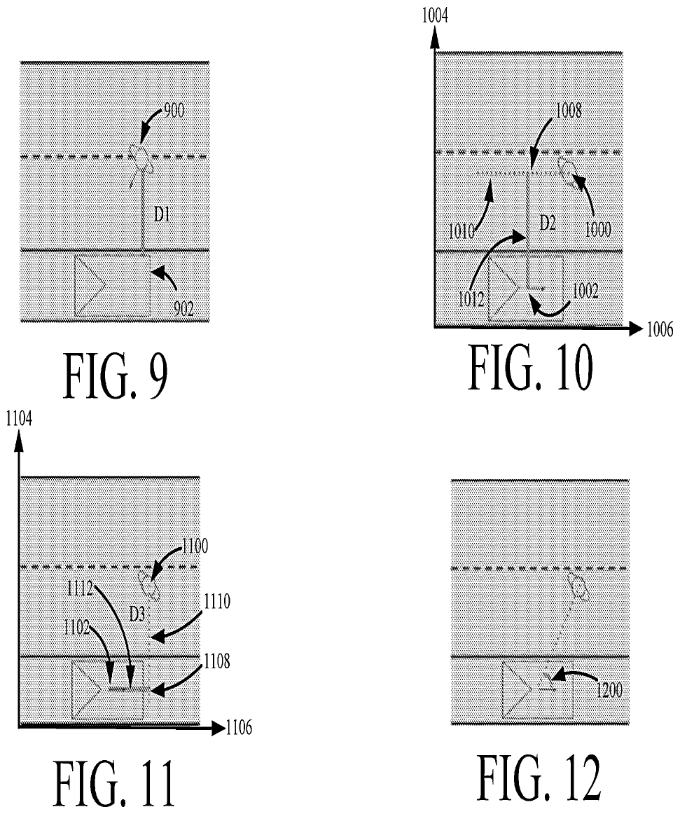

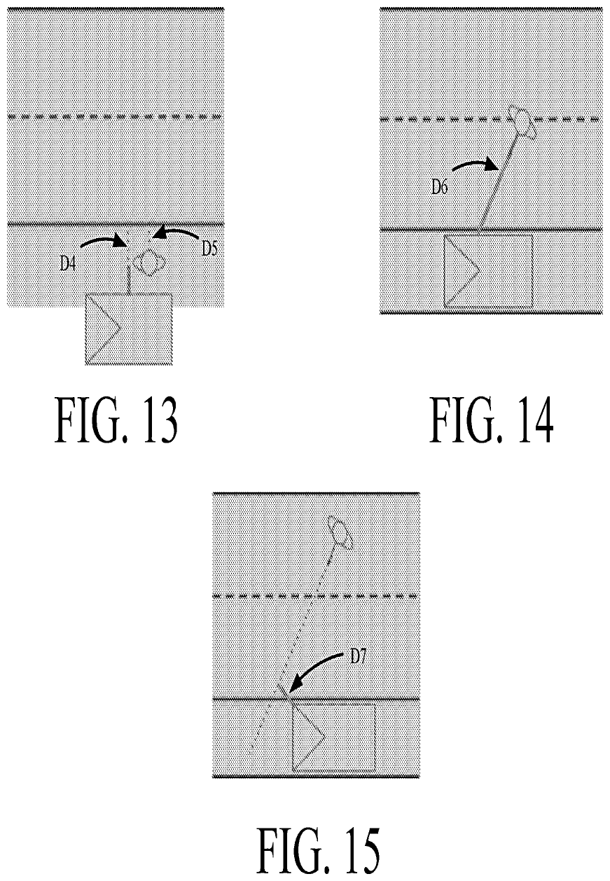

In contrast, if a closest parked vehicle is identified for a pedestrian [808:YES], then the computing device(s) perform(s) operations in block 812 to extract social feature(s) which describe a behavior of each pedestrian in relation to the respective closest parked vehicle. The social feature(s) include, but is(are) not limited to, a probability that a vehicle is parked, a distance from a pedestrian to a vehicle's bounding box (for example, distance D1 between pedestrian 900 and bounding box 902 as shown in FIG. 9), a distance in the X direction between a pedestrian's center axis and a vehicle's center point (for example, distance D2 along the X axis 1004 between the vehicle's center point 1002 and an intersection point 1008 between a first line 1010 extending from the pedestrian's center axis 1000 along the Y axis 1006 in a direction towards the vehicle and a second line 1012 extending from the vehicle's center point 1002 along the X axis 1004 in a direction towards the pedestrian as shown in FIG. 10), a distance in the Y direction between a pedestrian's center axis and a vehicle's center point (for example, distance D3 along the Y axis 1106 between the vehicle's center point 1102 and an intersection point 1108 between a first line 1110 extending from the pedestrian's center axis 1100 along the Y axis 1106 in a direction towards the vehicle and a second line 1112 extending from the vehicle's center point 1102 along the X axis 1104 in a direction towards the pedestrian as shown in FIG. 11), an angle of the pedestrian in the vehicle frame (for example, angle 1200 of FIG. 12), a difference in a distance from the pedestrian to a boundary of a closest lane and a distance from the parked vehicle to the boundary of the closest lane (for example, a difference between distances D4 and D5 of FIG. 13), a distance along a course ray to a bounding box of the parked vehicle (for example, distance D6 of FIG. 14), and a distance between a course ray and the bousing box of the parked vehicle (for example, distance D7 of FIG. 15).

The extracted social feature(s) is(are) used by the computing device(s) to generate a likelihood that each detected pedestrian has an intent to jaywalk, as shown by block 814. Other information may additionally be used to generate the likelihood value(s). A jaywalking classifier can be employed to generate the likelihood values. The jaywalking classifier can include, but is not limited to, a neuronal network-based classifier, a RF classifier, and/or an SVM classifier. Subsequently, block 816 is performed where method 800 ends or other operations are performed (for example, return to 802).

As evident from the above discussion, the present disclosure concerns implementing systems and methods for detecting and using intensions of living actors in an environment. The living actors can include, but are not limited to, humans (e.g., pedestrian 116 of FIG. 1) and/or other animals. The methods can be performed by one or more computing devices. The computing devices include, but are not limited to, an on-board computing device (for example, vehicle on-board computing device 220 of FIG. 2) of a robotic system (e.g., vehicle 102 of FIG. 1) and/or by a remote computing device (for example, computing device 110 of FIG. 1).

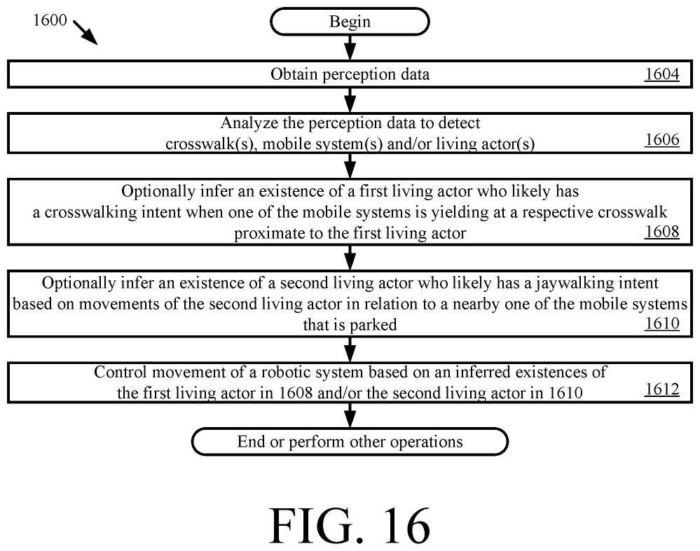

In some scenarios, the methods comprise the operations shown in blocks 1604-1612 of FIG. 16. These operations involve: obtaining perception data associated with the environment; analyzing the perception data to detect any crosswalks, mobile systems (e.g., vehicle(s) 103 of FIG. 1 and/or robotic system) and living actors (e.g., pedestrian(s) 116 of FIG. 1) traveling on foot in the environment; inferring an existence of (a) a first living actor who likely has a crosswalking intent when one of the mobile systems is yielding at a respective crosswalk of the crosswalks proximate to the first living actor and/or (b) a second living actor who likely has a jaywalking intent based on movements of the second living actor in relation to a nearby one of the mobile systems that is parked; and controlling movement of a robotic system (e.g., vehicle 102 of FIG. 1) based on an inferred existence of (a) and/or (b).

In some scenarios, existence of the first living actor is inferred by: identifying at least one mobile system from the mobile systems that is classified as a yielding system and is located in front of one the crosswalks that were detected; and reclassifying the at least one mobile system as a crosswalk yielding system. Additionally, this inference is achieved by: obtaining a likelihood value indicating how likely an intent of the first living actor is to cross along the respective crosswalk; and increasing the likelihood value when the first living actor is located on or near the respective crosswalk at which one of the mobile systems is yielding. The existence of the first living actor is inferred when, for example, the likelihood value is greater than a threshold value (for example, 5 when the likelihood value falls between 0 and 10). The likelihood value may be increased by an amount based on (i) a presence of one or more yielding vehicles at the respective crosswalk, (ii) a number of yielding vehicles or queuing vehicles at the respective crosswalk, (iii) likelihood values associated with the one or more yielding vehicle classifications, (iv) geometric reasoning information associated with the first living actor and the respective crosswalk, and/or (v) geometric reasoning information associated with the robotic system and the respective crosswalk.

In those or other scenarios, existence of the second living actor is inferred by: identifying at least one mobile system from the mobile systems that is closest to the second living actor; extracting at least one social feature which describes a behavior of the second living actor in relation to the at least one mobile system which was identified; and using the at least one social feature to generate a likelihood that each living actor which was detected has an intent to jaywalk. The existence of the second living actor is inferred when, for example, the likelihood is greater than a threshold value (for example, 5 when the likelihood value falls between 0 and 10). The social feature can include, but is not limited to, a probability that a vehicle is parked, a distance from a pedestrian to a vehicle's bounding box, a distance in an X direction between a pedestrian's center axis and a vehicle's center point, a distance in a Y direction between the pedestrian's center axis and the vehicle's center point, an angle of the pedestrian in a vehicle frame, a difference in a distance from the pedestrian to a boundary of a closest lane and a predefined distance from a parked vehicle to the boundary of the closest lane, a distance along a course ray to a bounding box of the parked vehicle, and a distance between a course ray and the bousing box of the parked vehicle.

In those or other scenarios, the perception data analyzing results in an identification of any mobile systems that are located on or near one of the crosswalks, any living actors that are located on or near the crosswalks, and/or any living actors that are located in proximity to road edges. Additionally or alternatively, the methods involve making an assumption that a third living actor exists with a crosswalking intent when (i) no living actor was detected during the analyzing as being on or near a given crosswalk of the crosswalks and (ii) one of the mobile systems is located on or near the given crosswalk and is classified as a crosswalk yielding system. While reference is made to “near” within this document, such reference may be understood as being a predefined distance from an object such as a cross walk or parked vehicle. Such distance may be a certain radius or distance such as five feet, but varying distances may be contemplated.

The implementing systems can comprise: a processor; and a non-transitory computer-readable storage medium comprising programming instructions that are configured to cause the processor to implement a method for operating an automated system. The above described methods can also be implemented by a computer program product comprising a memory and programming instructions that are configured to cause a processor to perform operations.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

What is claimed is:

1. A method for detecting and using intentions of living actors in an environment of a vehicle, comprising:
obtaining, by a computing device, perception data associated with the environment;
analyzing, by the computing device, the perception data to detect crosswalks, other vehicles and living actors that are traveling on foot in the environment; and
inferring, by the computing device, an existence of at least one of (a) a first living actor having a crosswalking intent in response to one of the vehicles indicating yielding at a respective crosswalk of the crosswalks proximate to the first living actor and (b) a second living actor having a jaywalking intent based on movements of the second living actor within a predefined distance of one of the vehicles that is parked.

2. The method according to claim 1, further comprising controlling movement the vehicle based on an inferred existence of at least one of the first living actor and the second living actor.

3. The method according to claim 2, wherein the living actors include at least one pedestrian.

4. The method according to claim 1, wherein the inferring of the existence of at least one of a first living actor and a second living actor includes identifying that at least one of the vehicles is within a predefined distance of one of the crosswalks and is determined to be yielding.

5. The method according to claim 4, further comprising:
obtaining a likelihood value indicating how likely an intent of the first living actor is to cross along the respective crosswalk; and
increasing the likelihood value in response to the first living actor being located on the respective crosswalk at which one of the vehicle is yielding.

6. The method according to claim 5, wherein the likelihood value is increased by an amount based on at least one of (i) a presence of one or more yielding vehicles at the respective crosswalk, (ii) a number of yielding vehicles or queuing vehicles at the respective crosswalk, (iii) likelihood values associated with the one or more yielding vehicle classifications, (iv) geometric reasoning information associated with the first living actor and the respective crosswalk, and (v) geometric reasoning information associated with the vehicle and the respective crosswalk.

7. The method according to claim 1, wherein the inferring of the existence of at least one of a first living actor and a second living actor includes:
identifying at least one of the vehicles that are closest to the second living actor;
extracting at least one social feature indicative of a behavior of the second living actor in relation to the at least one vehicle; and
using the at least one social feature to generate a likelihood that the second living actor intends to jaywalk.

8. The method according to claim 7, wherein the at least one social feature includes a probability that a vehicle is parked, a distance from a pedestrian to a vehicle's bounding box, a distance in an X direction between a pedestrian's center axis and a vehicle's center point, a distance in a Y direction between the pedestrian's center axis and the vehicle's center point, an angle of the pedestrian in a vehicle frame, a difference in a distance from the pedestrian to a boundary of a closest lane and a distance from a parked vehicle to the boundary of the closest lane, a distance along a course ray to a bounding box of the parked vehicle, and a distance between a course ray and the bousing box of the parked vehicle.

9. The method according to claim 1, wherein the analyzing further includes identifying the vehicles that are located on the crosswalks, the living actors that are located on the crosswalks, and the living actors that are located in predefined proximity to road edges.

10. The method according to claim 1, wherein the inferring further includes making an assumption that a third living actor exists with a crosswalking intent when (i) no living actor was detected during the analyzing as being on a given crosswalk of the crosswalks and (ii) one of the vehicles is located on the given crosswalk and is classified as a crosswalk yielding system.

11. A system, comprising:
a processor;
a non-transitory computer-readable storage medium comprising programming instructions that are configured to cause the processor to implement a method for detecting and using intentions of living actors in an environment, wherein the programming instructions comprise instructions to:
obtain perception data associated with the environment;
analyze the perception data to detect any crosswalks, vehicles and living actors that are traveling on foot in the environment; and
infer an existence of at least one of (a) a first living actor having a crosswalking intent in response to one of the vehicles indicating yielding at a respective crosswalk of the crosswalks proximate to the first living actor and (b) a second living actor having a jaywalking intent based on movements of the second living actor within a predefined distance of one of the vehicles that is parked.

12. The system according to claim 11, wherein the programming instructions further include instructions to control movement of the vehicle based on an inferred existence of at least one of the first living actor and the second living actor.

13. The system according to claim 12, wherein the existence of the first living actor is inferred by:
identifying that at least one vehicle is within a predefined distance of one of the crosswalks and is determined to be yielding.

14. The system according to claim 12, wherein the existence of the first living actor is inferred by:
obtaining a likelihood value indicating how likely an intent of the first living actor is to cross along the respective crosswalk; and
increasing the likelihood value in response to the first living actor is located on the respective crosswalk at which one of the vehicles is yielding.

15. The system according to claim 14, wherein the likelihood value is increased by an amount based on at least one of (i) a presence of one or more yielding vehicles at the respective crosswalk, (ii) a number of yielding vehicles or queuing vehicles at the respective crosswalk, (iii) likelihood values associated with the one or more yielding vehicle classifications, (iv) geometric reasoning information associated with the first living actor and the respective crosswalk, and (v) geometric reasoning information associated with the vehicle and the respective crosswalk.

16. The system according to claim 11, wherein the existence of the second living actor is inferred by:
identifying that the vehicles that are closest to the second living actor;
extracting at least one social feature indicative of a behavior of the second living actor in relation to the at least vehicle; and
using the at least one social feature to generate a likelihood that the second actor intends to jaywalk.

17. The system according to claim 16, wherein the at least one social feature includes a probability that a vehicle is parked, a distance from a pedestrian to a vehicle's bounding box, a distance in an X direction between a pedestrian's center axis and a vehicle's center point, a distance in a Y direction between the pedestrian's center axis and the vehicle's center point, an angle of the pedestrian in a vehicle frame, a difference in a distance from the pedestrian to a boundary of a closest lane and a distance from a parked vehicle to the boundary of the closest lane, a distance along a course ray to a bounding box of the parked vehicle, and a distance between a course ray and the bousing box of the parked vehicle.

18. The system according to claim 11, wherein the programming instructions further include instructions to analyze the perception data to identify the vehicles that are located at one of the crosswalks, the living actors that are located on the crosswalks, and the living actors that are located in a predefined proximity to road edges.

19. The system according to claim 11, wherein the programming instructions further include instructions to make an assumption that a third living actor exists with a crosswalking intent when (i) no living actor was detected during the analyzing as being on a given crosswalk of the crosswalks and (ii) one of the vehicles is located on the given crosswalk and is classified as a crosswalk yielding system.

20. A non-transitory computer-readable medium that stores instructions that is configured to, when executed by at least one computing device, cause the at least one computing device to perform operations comprising:
obtaining perception data associated with the environment;
analyzing the perception data to detect any crosswalks, mobile systems and living actors that are traveling on foot in the environment; and
inferring an existence of at least one of (a) a first living actor who likely has a crosswalking intent when one of the mobile systems is yielding at a respective crosswalk of the crosswalks proximate to the first living actor and (b) a second living actor who likely has a jaywalking intent based on movements of the second living actor in relation to a nearby one of the mobile systems that is parked.
